(19) United States
(12) Patent Application Publication
(10) Pub. No.: US 2026/0253761 A1
(43) Pub. Date: Aug. 27, 2026

(54) ION COLLECTION ASSEMBLY WITH A HALBACH ARRAY SUPPRESSION MAGNET

(71) Applicant: SHINE Technologies, LLC, Janesville, WI (US)

(72) Inventors: Dominic Marquez, Janesville, WI (US); Josh Blatz, Monona, WI (US)

(21) Appl. No.: 19/547,980

(22) Filed: Feb. 24, 2026

Related U.S. Application Data
(60) Provisional application No. 63/762,853, filed on Feb. 25, 2025.

(51) Int. Cl. G21K 1/20

(52) U.S. Cl. CPC G21K 1/20

(57) ABSTRACT

An ion collection assembly that includes a target housing, a collection target positioned in the target housing, wherein the collection target is configured to collect ions of an ion beam impinging the collection target, and a suppression magnet arranged in a Halbach array and positioned around the target housing.

### CROSS-REFERENCE TO RELATED APPLICATIONS

This application claims the benefit of U.S. Provisional Application No. 63/762853 filed on Feb. 25, 2025 which is incorporated herein by reference in its entirety.

### TECHNOLOGY

The present disclosure relates generally to systems and methods of ion beam generation and use.

### BACKGROUND

Previous technologies that involve ion beams are typically intended to provide high-energy collisions between the ion beam and a substrate material, in order to create changes to the substrate material. Ion beam implantation is often used is semiconductor and material modification applications. Such systems and methods do not provide for high-efficiency collection of the ions by themselves (i.e., turning an ion beam back into a solid). One goal of the present application is collection of the ions of the ion beam as a constituted material which can be collected, stored, transported, used, etc., for example in health care applications.

### SUMMARY

According to one embodiment of the present disclosure, an ion collection assembly that includes a target housing, a collection target positioned in the target housing, wherein the collection target is configured to collect ions of an ion beam impinging the collection target, and a suppression magnet arranged in a Halbach array and positioned around the target housing.

According to another embodiment of the present disclosure, an ion production system includes an ion source configured to produce ions, an extraction electrode positioned between the ion source and a collection target and configured to accelerate ions, forming an ion beam along a beam pathway, and a bending magnet positioned along the beam pathway between the extraction electrode and a mass resolving aperture. The bending magnet is configured to apply a magnetic field to the ion beam thereby spatially separating a target beam portion of the ion beam and a secondary beam portion of the ion beam and the mass resolving aperture is positioned to obstruct the secondary beam portion of the target beam. The ion production system also includes an ion collection assembly comprising a target housing; wherein the collection target is positioned in the target housing and a suppression magnet arranged in a Halbach array is positioned around the target housing.

According to yet another embodiment of the present disclosure, a method includes accelerating ions from an ion source to form an ion beam using an extraction electrode positioned between the ion source and a mass resolving aperture, wherein the ion beam propagates along a beam pathway toward a collection target, applying a first magnetic field to the ion beam using a bending magnet positioned along the beam pathway between the extraction electrode and the mass resolving aperture thereby spatially separating a target beam portion of the ion beam and a secondary beam portion of the ion beam, obstructing the secondary beam portion using the mass resolving aperture, and collecting ions of the target beam portion on the collection target after the target beam portion of the ion beam passes through the mass resolving aperture. The collection target is positioned in a target housing of an ion collection assembly and a suppression magnet arranged in a Halbach array is positioned around the target housing thereby applying a second magnetic field in the target housing such that electrons generated by the target beam portion of the ion beam striking the collection target are directed back toward the collection target.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 schematically depicts an ion production system, according to one or more embodiments shown and described herein;

FIG. 2 schematically depicts an ion collection assembly comprising a collection target positioned in a target housing and a suppression magnet positioned around the target housing, according to one or more embodiments shown and described herein;

FIG. 3A schematically depicts a suppression magnet arranged in a Halbach array that forms a linear magnetic field, according to one or more embodiments shown and described herein;

FIG. 3B schematically depicts a suppression magnet comprising a plurality of magnets arranged in a Halbach array that forms a linear magnetic field, according to one or more embodiments shown and described herein;

FIG. 4 schematically depicts a body of the suppression magnet, according to one or more embodiments shown and described herein;

FIG. 5 schematically depicts the body of FIG. 4 with a plurality of magnets positioned in a plurality of magnet slots and arranged in a Halbach array, according to one or more embodiments shown and described herein;

FIG. 6 graphically depicts beam current of an ion beam along a cross-sectional beam axis, according to one or more embodiments shown and described herein;

FIG. 7A schematically depicts an isometric view of an ion collection assembly, according to one or more embodiments shown and described herein;

FIG. 7B schematically depicts an exploded view of the ion collection assembly of FIG. 5, according to one or more embodiments shown and described herein;

FIG. 8A schematically depicts a suppression magnet arranged in a radially multi-layered Halbach array that forms a linear magnetic field, according to one or more embodiments shown and described herein;

FIG. 8B schematically depicts a suppression magnet comprising a plurality of magnets arranged in a radially multi-layered Halbach array that forms a linear magnetic field, according to one or more embodiments shown and described herein;

FIG. 9A schematically depicts a suppression magnet arranged in a polygonal Halbach array that forms a linear magnetic field, according to one or more embodiments shown and described herein;

FIG. 9B schematically depicts another suppression magnet arranged in a polygonal Halbach array that forms a linear magnetic field, according to one or more embodiments shown and described herein;

FIG. 10A schematically depicts a suppression magnet arranged in a k=3 Halbach array, according to one or more embodiments shown and described herein;

FIG. 10B schematically depicts a suppression magnet arranged in a k=4 Halbach array, according to one or more embodiments shown and described herein;

FIG. 11 schematically depicts an exploded view of an embodiment of the collection target of an ion production system, according to one or more embodiments shown and described herein; and

FIG. 12 schematically depicts a perspective view of a fibrous lattice of a collection target of an ion production system, according to one or more embodiments shown and described herein.

### DETAILED DESCRIPTION

Referring generally to the figures, embodiments of the present disclosure are directed to an ion collection assembly for use in a system that uses an ion beam, such as an ion production system. The ion production system includes an ion source, one or more extraction electrodes, a bending magnet, a mass resolving aperture, an ion collection assembly. The ion source produces ions which are accelerated, forming an ion beam. The mass resolving aperture is positioned and configured to allow passage of a target beam portion of an ion beam (e.g., a portion that includes a target isotope) while obstructing a secondary beam portion of the ion beam (e.g., a portion that includes one or more secondary isotopes). The ion collection assembly includes a collection target for collecting the target beam portion of the ion beam. The ion collection assembly may be incorporated into a heavy metal ion production system configured to perform high-efficiency collection of ions (e.g., heavy metal ions such as ytterbium ions including ytterbium-176 ions) at the collection target, such that the ions are reconstituted as a material which can then be collected, stored, transported, used, etc. for various applications (e.g., a material having a high concentration of ytterbium-176 or other target isotope).

The collection target is positioned in a target housing and the ion collection assembly further includes a suppression magnet positioned around the target housing. The suppression magnet is arranged in a Halbach array which generates a magnetic field in the target housing that minimizes current loss caused by secondary electron generation in the collection target, allowing the collection target to maintain a fully captured charge. Accurate measurement the current in the collection target provides a real time-measurement of the current of the ion beam striking and collecting in the collection target, which correlates to the amount of target isotopes reaching the target and provides an accurate measurement regarding whether any secondary isotopes are also reaching the target. Embodiments of the ion collection assembly, the ion production system and uses thereof will now be described and, whenever possible, the same reference numerals will be used throughout the drawings to refer to the same or like parts.

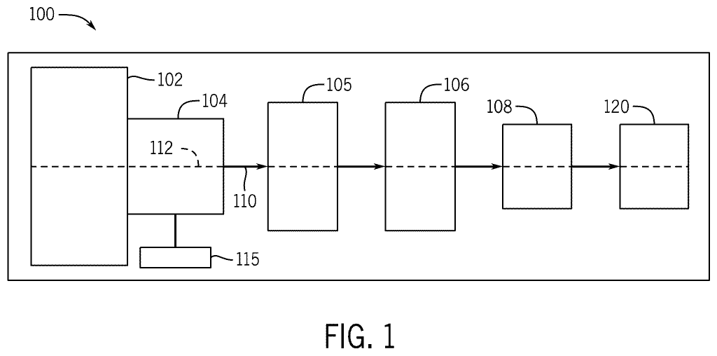

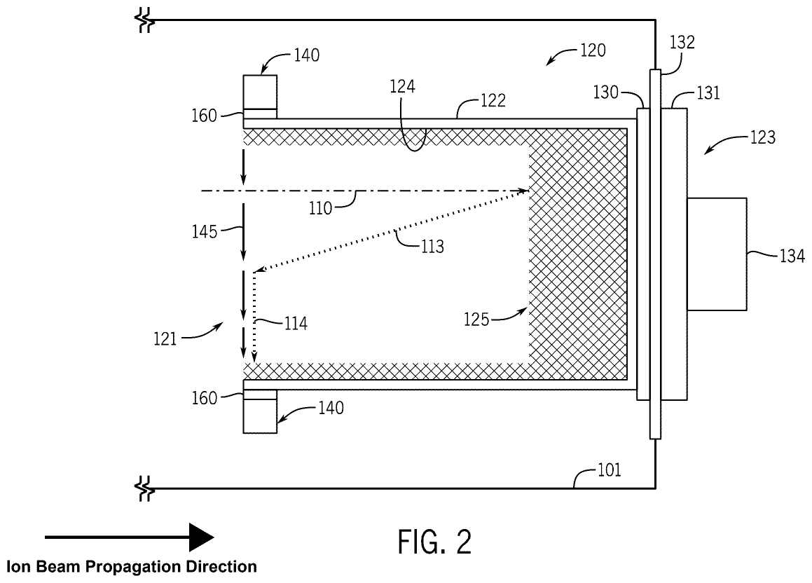

Referring now to FIG. 1, a block diagram of an ion production system 100 is shown, according to an illustrative embodiment. The ion production system 100 may include an ion source 102, one or more extraction electrodes 104, one or more beam shaping elements 105, a bending magnet 106, a mass resolving aperture 108, an ion collection assembly 120. The ion source 102 is configured to generate an ion beam 110 that is accelerated along an ion beam pathway 112 by the extraction electrodes 104 and collected by a collection target 125 (FIG. 2) of the ion collection assembly 120. The ion source 102, the one or more extraction electrodes 104, the one or more beam shaping elements 105, the bending magnet 106, the mass resolving aperture 108, and the ion collection assembly 120 are arranged along the ion beam pathway 112.

Referring now to FIGS. 1 and 2, the ion source 102 is configured to produce ions. The ion source 102 may be configured as a Bernas or Freeman ion source, which includes a filament operable to emit electrons which ionize a gas provided into the ion source 102, for example a heavy metal gas such as a ytterbium vapor or a gadolinium vapor. It should be understood that the ion source 102 may comprise any known or yet to be developed ion source, for example, a (Duo)Plasmatron source, a Magnetron source (e.g., a Freeman source), a Penning-style source (e.g., Bernas, Calutron, Nielson, or PIG/penning ionization gauge sources), an electron cyclotron resonance ion source, a sputter source, a radiofrequency discharge source, a laser ionization source, a surface ionization source, a vacuum arc source, or the like

Other metals (lutetium, technetium, tellurium, etc.) may also be used. Interactions between the electrons and the gas ionize the gas to produce ions. In some embodiments, the ion source 102 produces positive ions (i.e., “cations,” ions having a positive polarity). In other embodiments, the ion source 102 produces negative ions (i.e., “anions,” ions having a negative polarity). While the examples of the present disclosure refer to ion sources and ion beams, it should be understood other charged particle sources are contemplated and applicable, such as a plasma source configured to generate a plasma beam. The ion source 102 includes an outlet slit or aperture so that the ions or other charged particles can be extracted from the ion source 102. In some embodiments, the ion source 102 includes auxiliary heaters to protect elements of the ion source 102 and to improve uniformity of the ions for extraction from the ion source 102.

The one or more extraction electrodes 104 may include one or more electrodes to accelerate the ion beam 110, shape the ion beam 110, aim the ion beam 110, etc. By providing an electric field that accelerates the ion beam 110 out of the ion source 102, the one or more extraction electrodes 104 provide the ion beam 110 with an extraction energy of the same or similar magnitude as a voltage of the one or more extraction electrodes 104. In some embodiments, accelerating ions from the ion source 102 to form the ion beam 110 comprises providing the ions with energies greater than 100 volts (V). A voltage source 115 is connected to the one or more extraction electrodes 104. The voltage source 115 operates as an extraction power supply such that, in operation, the ion source 102 and the one or more extraction electrodes 104 form and accelerate the ion beam 110 along the ion beam pathway 112, such that the ion beam 110 propagates along the ion beam pathway 112 toward the collection target 125.

The ion beam 110 may comprise a plurality of isotopes of the one or more ions. In some embodiments, only some of these isotopes are desired for capture at the collection target 125. As used herein, such isotopes are referred to as target isotopes. The other, non-target isotopes of the ion beam 110 are referred to herein as secondary isotopes.

In the example of FIG. 1, the ion beam 110 passes from the one or more extraction electrodes 104 to the one or more beam shaping elements 105 and the bending magnet 106. The one or more beam shaping elements 105 are optional and may include, for example, Einzel lens, quadrupole focusing elements, or the like. The one or more beam shaping elements 105 may be positioned between the ion source 102 and the bending magnet 106 or between the bending magnet 106 and the mass resolving aperture 108. The bending magnet 106 is configured to provide a magnetic field (e.g., a first magnetic field) that applies magnetic forces on the ion beam 110. For example, the magnetic force on each ion of the ion beam 110 may be approximately equal, but the ion beam 110 may include ions of different isotopes, such that the masses of the ions vary. The magnetic force provided by the bending magnet 106 may result in a separation of ions by mass. Thus, after passing through the bending magnet 106, different areas of a transverse cross-section of the ion beam 110 may include different isotopes, i.e., ions of different mass. In other words, the magnetic field spatially separates the different isotopes in a direction non-parallel to a propagation direction of the ion beam 110, for example along a cross-sectional axis. It should be understood that other techniques for spatially separating the ion beam 110 are contemplated that do not use the bending magnet 106.

In operation, the ion beam 110 passes from the bending magnet 106 to the mass resolving aperture 108, which blocks an undesired subset of the particles (i.e., a secondary beam portion comprising the one or more secondary isotopes) from passing through the mass resolving aperture 108, while allowing desired particles (i.e., the target beam portion comprising the one or more target isotopes) to pass through the mass resolving aperture 108. This is achieved by positioning the mass resolving aperture 108 relative to the bending magnet 106 to take advantage of the separation of isotopes by mass achieved by the bending magnet 106. Thus, by including the bending magnet 106 and the mass resolving aperture 108, the ion beam 110 that reaches the collection target 125 includes a high percentage of a target isotope(s), with a low percentage of contamination by ions of different isotopes (i.e., secondary isotopes).

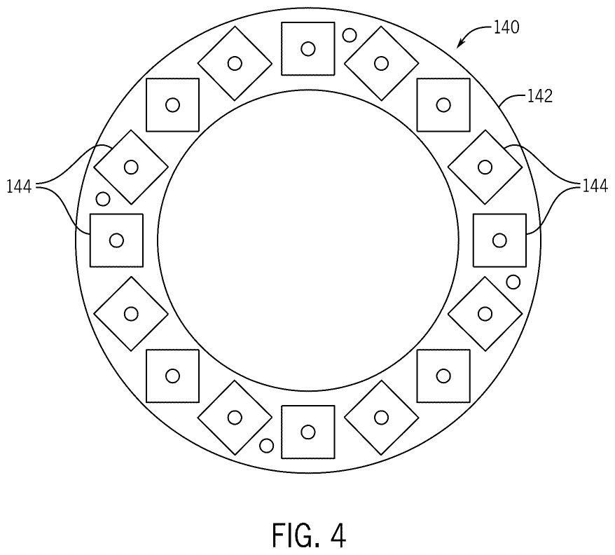

Referring now to FIGS. 2-5, the ion collection assembly 120 includes a target housing 122 having an entrance opening 121 opposite a closed end 123. The collection target 125 is positioned in the target housing 122 such that the ion beam 110 enters the target housing 122 through the entrance opening 121 and impinges the collection target 125. In operation, the portion of the ion beam 110 that passes through the mass resolving aperture 108 (e.g., the target beam portion) is incident on the collection target 125, which is configured to receive and collect the particles of the ion beam 110. The collection target 125 may line an inner surface 124 of the target housing 122. The collection target 125 comprises a substrate material suitable for receiving and retaining the particles of the ion beam 110, including as a film on a surface of the collection target 125 and/or embedded in the collection target 125. The collection target 125 is electrically conductive. The collection target 125 may comprise a carbon fiber material, such as a carbon fiber cloth, a fibrous lattice, such as a carbon fiber lattice (e.g., graphite fibers), or the like. In some embodiments, the collection target 125 comprises a crystal structure. Ion collection may be performed in high vacuum (e.g., pressure less than 10 mPa) in order to avoid contamination between the particles of interest for production and air or other contaminants. As such, a vacuum chamber 101 (sealed enclosure, hermetic box, etc.) can be provided to contain various components of the ion production system 100, for example, at least the ion collection assembly 120.

The ion collection assembly 120 further comprises a suppression magnet 140 positioned around the target housing 122, for example, at the entrance opening 121 of the target housing 122. The suppression magnet 140 is arranged in a Halbach array that generates a magnetic field (e.g., a second magnetic field) in the target housing 122 having magnetic field lines 145 that direct electrons generated by the ion beam 110 striking the collection target 125 (e.g., secondary electrons) back to the collection target 125, for example, toward a portion of the collection target 125 near the location of the suppression magnet 140. Without intending to be limited by theory, a Halbach array is a magnetic arrangement that augments the magnetic field on one side of the array while canceling the field to near zero on the other side. An annular Halbach array is a magnetized annulus that augments the magnetic field either inside or outside of the annulus while cancelling the field to near zero on the opposite side (i.e., either inside or outside the annulus). Annular Halbach arrays comprise a wavenumber (e.g., a k value). An annular Halbach array comprising a k value of 1 (i.e., a “k=1 annular Halbach array”), generates a magnetic field that is entirely outside the annulus, with zero field inside. Annular Halbach arrays comprising a k value of 2 or greater generate a magnetic field that is entirely inside the annulus, with zero magnetic field outside the annulus. Since the suppression magnet 140 is used to control secondary electrons within the target housing 122 (i.e., inside the annulus), the suppression magnet 140 comprises an annular Halbach array with a k value of 2 of greater.

As depicted in FIG. 2, the ion beam 110 enters the target housing 122 and impinges the collection target 125, which may generate a secondary electron that releases from the collection target 125 and propagates along an initial electron path 113. Along the initial electron path 113, the secondary electron may be propagating toward the entrance opening 121 of the target housing 122 such that, without alteration, the secondary electron would exit the target housing 122. However, as shown in FIG. 2, the suppression magnet 140 generates a magnetic field in the target housing 122 (e.g., within the portion of the target housing 122 circumscribed by the suppression magnet 140) having magnetic field lines 145 that point towards the inner surface 124 of the target housing 122 and thus toward the portion of the collection target 125 lining the inner surface 124 of the target housing 122. As shown in FIG. 2, when the secondary electron reaches the magnetic field lines 145, the path of the electron is altered and the electron follows an augmented electron path 114 toward the inner surface 124 of the target housing 122 and the collection target 125. Thus, the magnetic field generated by the suppression magnet 140 directs the secondary electron back to the collection target 125. The suppression magnet 140 allows for a larger entrance opening 121 without increasing secondary electron loss. In operation, the suppression magnet 140 generates a magnetic field (e.g., the second magnetic field) comprising magnetic field lines 145 within the target housing 122 with a magnetic flux density of 0.5 kilogauss (kG) or greater, for example, 0.75 kG or greater, 1 kG or greater, 1.5 KG or greater, 2 kG or greater, 2.5 kG or greater, 3 KG or greater, or the like. Moreover, when the suppression magnet 140 is positioned at the entrance opening 121, the magnetic field generated by the suppression magnet 140 may also prevent electrons external to the ion collection assembly 120 from entering the target housing 122 and reaching the collection target 125.

Directing secondary electrons back to the collection target 125 allows the collection target 125 to maintain a fully captured charge, facilitating accurate measurements of current in the collection target 125. Because the collection target 125 is electrically conductive, the electrons of the ion beam 110 hitting the collection target 125 generate a beam current signal in the collection target 125 that may be measured to determine the total mass of ions collecting in the collection target 125 in real time. The collection target 125 may be communicatively coupled to a beam monitor which receives and outputs (e.g., on a display) the beam current. Beam current measurements can indicate where the spatial separation between the target isotopes and the secondary isotopes is sufficient to isolate the target isotope using the mass resolving aperture 108, which provides an indication of the purity level of the collected target isotope. Real time beam current measurements can also provide an indication that the ion beam 110 is off target with respect to the mass resolving aperture 108.

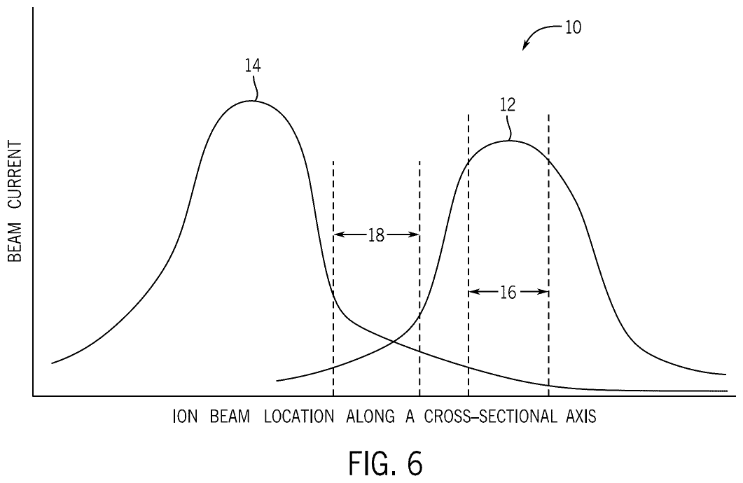

Referring now to FIG. 6, graph 10 depicts beam current along a cross-sectional axis of the ion beam 110. Graph 10 is an example of how the beam current of the ion beam 110 provides a real time diagnostic tool. As noted above, after passing through the bending magnet 106, different areas of a transverse cross-section of the ion beam 110 may include different isotopes, i.e., ions of different mass. Line 12 graphically depicts the beam current of the target isotope, such as Yb-176, which is spatially separated from the one or more secondary isotopes, for example, an adjacent secondary isotope, such as Yb-174. Line 14 graphically depicts the beam current of the adjacent secondary isotope. As depicted in FIG. 6, when the portion of the ion beam 110 that passes through the mass resolving aperture 108 is in a target collection window 16, the target portion of the ion beam 110 reaches that collection target 125, which can be confirmed in real time based on the beam current shown by line 12. For example, the target portion of the ion beam 110 has a peak beam current indicative of proper alignment of the ion beam 110. A decrease in beam current can be indicative that the ion beam is no longer in the target collection window 16. If the ion beam 110 shifts off target, the portion of the ion beam 110 that passes through the mass resolving aperture 108 may shift into a misaligned collection window 18. Reduced beam current is indicative of the ion beam 110 shifting along the cross-sectional axis such that less of the target isotope and more of the secondary isotopes are reaching the collection target 125, reducing the amount of target isotope collected while also contaminating the collected target isotope. Further drift may align the ion beam 100 with the adjacent secondary isotope such that the measured beam current is the beam current depicted by line 14. Thus, beam current measurements provide real time diagnostics on the ion beam 110.

Moreover, suppressing the secondary electrons improves the accuracy of the beam current measurements thus improving the accuracy of beam diagnostics.

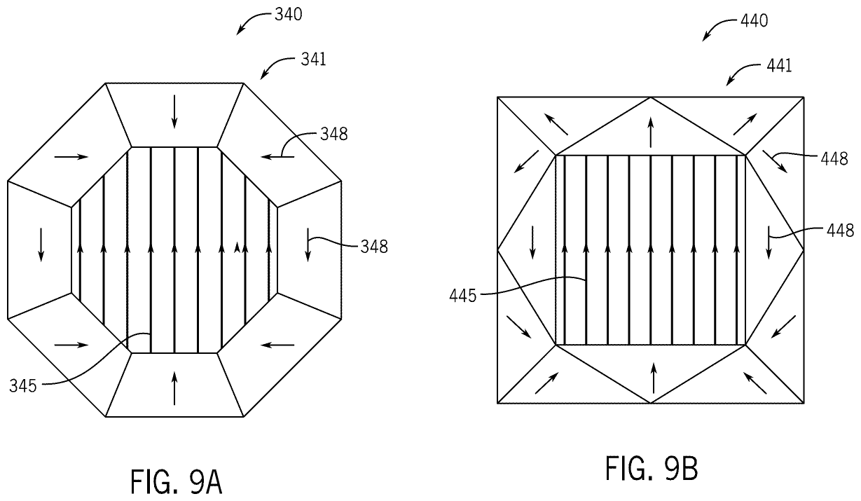

Referring again to FIGS. 2-5, the target housing 122 may be cylindrical and the suppression magnet 140 may comprise a body 142 that surrounds the target housing 122. The body 142 may comprise an annular body, as depicted in FIGS. 2-5, however, it should be understood that the body 142 of the suppression magnet 140 does not have to be annular and can be any shape that encircles the target housing 122. In some embodiments, the suppression magnet 140 comprises an electromagnet that operates as a Halbach array. In some embodiments, as depicted in FIGS. 2-5, the suppression magnet 140 comprises a plurality of permanent magnets 146, for example permanent ferromagnets, such as neodymium magnets, arranged in a Halbach array. The plurality of permanent magnets 146 do not require power to operate, which simplifies the suppression magnet 140 since there is no need for electrical standoffs, which are used for electrical potential suppression. When the suppression magnet 140 comprises the plurality of permanent magnets 146, the body 142 comprises a plurality of magnet slots 144 and the plurality of permanent magnets 146 may be positioned in the plurality of magnet slots 144. The plurality of permanent magnets 146 each comprise a local magnetic orientation 148. The local magnetic orientations 148, in collection, influence the magnetic field lines 145 generated by the suppression magnet 140. While the plurality of permanent magnets 146 in FIGS. 2-5 are depicted as square magnets, it should be understood the plurality of permanent magnets 146 may comprise a variety of shapes, such as angular shaped magnets shaped to allow the magnets to fit closer together, increasing the uniformity of the field and improving its strength, as shown in FIGS. 9A and 9B.

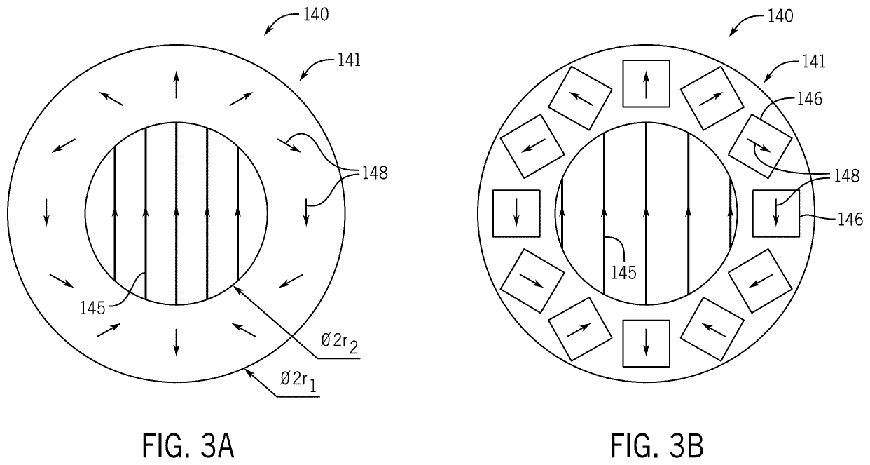

Referring again to FIGS. 3A and 3B, the suppression magnet 140 may comprise a k=2 annular Halbach array, which generates linear magnetic field lines (e.g., the magnetic field lines 145) across the entrance opening 121 of the target housing 122. Thus, secondary electrons generated by the ion beam 110 striking the collection target 125 are directed back into the collection target 125. In the embodiment depicted in FIG. 3B, the plurality of permanent magnets 146 are arranged in a k=2 annular Halbach array. In some embodiments, the plurality of permanent magnets 146 are rotated 30-degrees clockwise from each other (when measured traveling clockwise). In other words, the local magnetic orientation 148 of radially adjacent permanent magnets 146 are offset by 30 degrees. However, other rotation iterations are contemplated and the angular offset of the local magnetic orientation 148 of radially adjacent permanent magnets 146 may be reduced by increasing the total number of permanent magnets 146 in the annular Halbach array. Indeed, in a k=2 annular Halbach array, the plurality of permanent magnets 146 magnetic orientation 148 makes two full rotations within the array, which creates a uniform magnetic field. Because the k=2 Halbach array is a uniform field in one direction, all captured secondary electrons should impact the same side of the collection target 125.

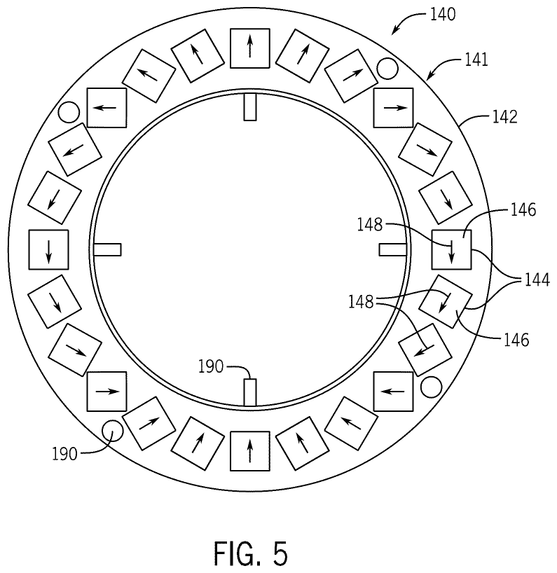

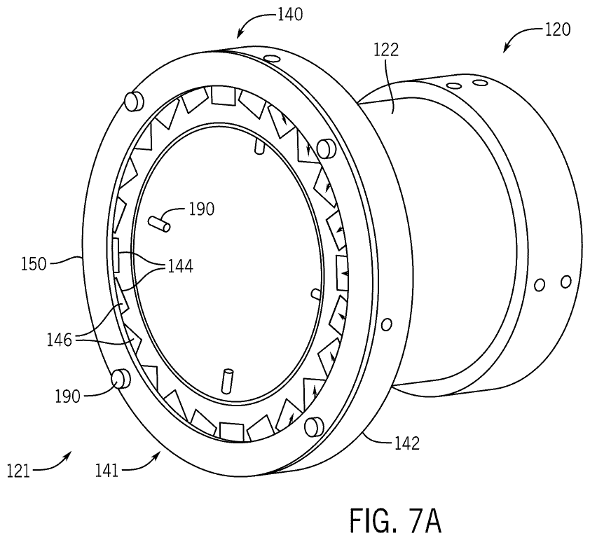

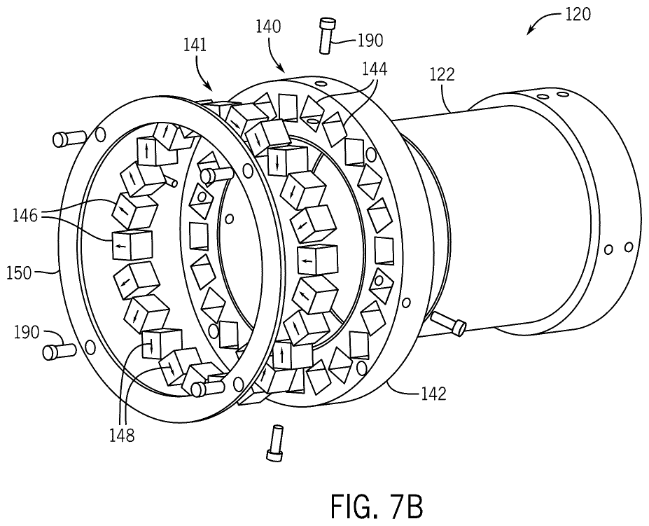

Referring now to FIGS. 7A and 7B, in some embodiments, the ion collection assembly 120 further comprises a lid 150 coupled to the body 142 covering a portion of the plurality of magnet slots 144 and a portion of the plurality of permanent magnets 146. As shown in FIG. 5, the lid 150 covers a portion of each of the plurality of magnet slots 144 and a portion of each of the plurality of permanent magnets 146. The lid 150 helps to hold the plurality of permanent magnets 146 in the plurality of magnet slots, for example, when the suppression magnet 140, together with the target housing 122 is tilted and spun. The lid 150 may comprise an inner radius that is larger than an inner radius of the body 142. The lid 150 is connected to the body 142 using one or more fasteners 190. In operation, the ion collection assembly 120 is positioned in the vacuum chamber 101 and ion collection occurs in a low-pressure environment. To accommodate such low-pressure environment, each magnet slot 144 of the body 142 includes holes to allow trapped air to escape. Moreover, the lid 150 covers a portion of each of the magnet slot 144, allowing trapped air to escape.

In some embodiments, the body 142 comprises aluminum. Aluminum minimizes the amount that the magnetic field generated by the plurality of permanent magnets 146 is suppressed by the body 142. Aluminum also provides high heat transfer for heat dissipation and is a low weight material, which helps the target housing 122 maintain rigidity. The body 142 is connected to the target housing 122 using one or more fasteners 190. While aluminum is described as an example material of the body 142, it should be understood that any material that minimally disrupts the magnetic field generated by the suppression magnet 140 is contemplated, such as copper, gold, or silver. In some embodiments, a cooling substrate 160 is positioned between the suppression magnet 140 and the target housing 122. The cooling substrate 160 may comprise a thermal conductive material, such as aluminum, copper, gold, silver, or the like, and may include one or more cooling elements, such as fluid flow channels, fins, or the like. In operation, the strength of the plurality of permanent magnets 146 decreases as temperature increases and, at high temperatures, can lose magnetism. Thus, the cooling substrate 160 may improve the performance and lifetime of the suppression magnet 140.

Referring again to FIG. 2, the collection target 125 and/or the target housing 122 is coupled to a magnetic rotation device that includes an interior plate (first plate) 130, and exterior plate (second plate) 131, and a motor 134. The interior plate 130 is inside (interior to, internal to, contained in) the vacuum chamber 101 and is positioned on an interior side of a flange 132 of the vacuum chamber 101. The exterior plate 131 is outside (exterior to, external to, not contained in) the vacuum chamber 101 and is positioned on an exterior side of the flange 132. The motor 134 is mechanically coupled to the exterior plate 131. The collection target 125 and/or the target housing 122 is mechanically coupled to the interior plate 130. The motor 134 is operable to drive rotation of the exterior plate 131. The motor 134 may be an electric motor, for example a stepper motor, which transforms electricity into rotational movement. The motor 134 is coupled to the exterior plate 131 such that operation of the motor 134 exerts a torque on the exterior plate 131 that causes rotation of the exterior plate 131 about an axis of the exterior plate 131. The motor 134 can be controllable to rotate the exterior plate 131 at various speeds.

The exterior plate 131 includes one or more magnets (e.g., permanent magnets) and the interior plate 130 also includes one or more magnets (e.g., permanent magnets) corresponding to the one or more magnets of the exterior plate 131. The magnets of the exterior plate 131 and the interior plate 130 are arranged such that an attractive force is exerted on the interior plate 130 by the exterior plate 131 and vice versa. For example, the one or more magnets of the exterior plate 131 may be arranged with a positive magnetic polarity facing the flange 132 while the one or more magnets of the interior plate 130 are arranged with a negative magnetic polarity facing the flange 132 (or vice versa), such that the magnets are attracted toward one another and a magnetic force pulls the interior plate 130 and the exterior plate 131 together. The magnets provide sufficiently strong magnetic fields to exert the attractive force across the flange 132.

Due to the attractive magnetic force between the magnets of the exterior plate 131 and the interior plate 130, rotation of the exterior plate 131 by the motor 134 causes rotation of the interior plate 130. In the examples shown, the interior plate 130 rotates to match the rotation of the exterior plate 131 due to magnetic coupling therebetween. Rotational movement and torque (e.g., angular kinetic energy) is thereby communicated across the flange 132 of the without compromising the integrity of a hermetic seal of the vacuum chamber 101 (e.g., without requiring mechanical engagement between the interior plate 130 and the exterior plate 131 that may be difficult to hermetically seal). Because, as shown in FIG. 2, the collection target 125 is connected to the interior plate 130, rotation of the interior plate 130 rotates the collection target 125. Although the examples herein refer to rotation, in other embodiments the motor 134 is arranged to translate the exterior plate 131 (e.g., in one or two dimensions) to thereby cause corresponding translation of the interior plate 130 and the collection target 125. Operation of the motor 134 thereby causes motion of the collection target 125, for example rotation of the collection target 125.

In operation, the ion beam 110 may be directed at the collection target 125 such that the ion beam 110 is misaligned (offset, etc.) relative to an axis of rotation of the collection target 125. Accordingly, when the collection target 125 rotates, the point or area at which the ion beam 110 is incident on the collection target 125 changes. Rotation of the collection target 125 over time causes the ion beam 110 to be incident on different portions of the collection target 125 over time, thereby increasing a total area of the collection target 125 that is exposed to the ion beam 110. Movement of the collection target 125 thereby allows a larger area of the collection target 125 to be exposed to the ion beam 110 and to capture target isotopes from the ion beam 110. The collection target 125 can thus capture more material as compared to an embodiment with a static collection target 125, allowing for longer continuous operation of the ion production system 100 before the collection target 125 is full (saturated, at capacity, etc.). Rotating the collection target 125 can also help reduce temperature gradients across the target, which may be undesirable.

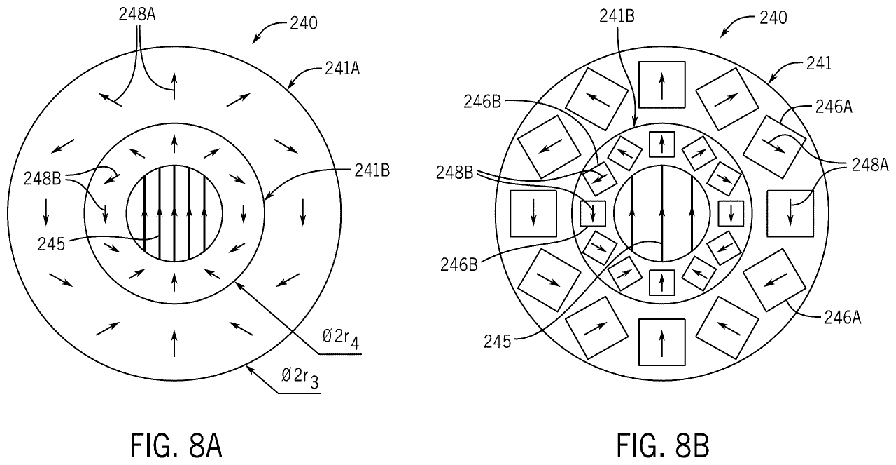

Referring now to FIGS. 8A-10B , suppression magnets 240, 340, 440, 540, 640, are schematically depicted and provide additional illustrative examples of suppression magnets arranged in a Halbach array that could be used in the ion collection assembly 120. FIGS. 8A and 8B schematically depicts a suppression magnet 240 arranged in a radially multi-layered Halbach array includes a first Halbach array 241A surrounding a second Halbach array 241B. Both the first Halbach array 241A and the second Halbach array 241B are a k=2 Halbach array. The first Halbach array 241A comprises a first collection of magnetic orientations 248A and the second Halbach array 241B comprises a second collection of magnetic orientations 248B which collectively influence magnetic field lines 245 formed by the suppression magnet 240. As shown in FIG. 8B, the first Halbach array 241A comprises a first plurality of permanent magnets 246A and the second Halbach array 241B comprises a second plurality of permanent magnets 246B. Nesting multiple Halbach arrays, such as the first and second Halbach arrays 241A, 241B, increases the strength of the generated magnetic field.

FIG. 9A schematically depicts a suppression magnet 340 arranged in a polygonal Halbach array 341 having magnetic orientations 348 that form a k=2 Halbach array and collectively influence magnetic field lines 345 formed by the suppression magnet 340. In particular, the polygonal Halbach array 341 is a hexagonal array. FIG. 9A schematically depicts a suppression magnet 440 arranged in a polygonal Halbach array 441 having magnetic orientations 448 that form a k=2 Halbach array and collectively influence magnetic field lines 445 formed by the suppression magnet 440. In particular, the polygonal Halbach array 341 is a square array. As shown by the examples of suppression magnets 340 and 440, it should be understood that the suppression magnet used in the ion collection assembly 120 does not have to be annular and can be any shape that encircles the target housing 122 of the ion collection assembly 120.

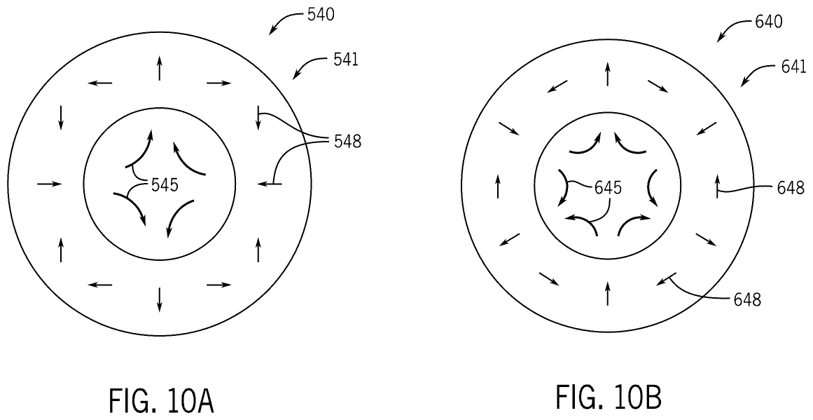

FIG. 10A schematically depicts a suppression magnet 540 arranged in a k=3 Halbach array 541, having magnetic orientations 548 which generate a magnetic field near the inner surface of the array that decreases near the central axis of the array, as depicted by the magnetic field lines 545. In a k=3 annular Halbach array, the magnetic orientation 548 makes three full rotations within the array, which creates a magnetic field with magnetic field lines 545. FIG. 10B schematically depicts a suppression magnet 640 arranged in a k=4 Halbach array 641, having magnetic orientations 648 which generate a magnetic field near the inner surface of the array that decreases near the central axis of the array, as depicted by the magnetic field lines 645. In a k=4 annular Halbach array, the magnetic orientation 648 makes four full rotations within the array, which creates a magnetic field with magnetic field lines 645. Without intending to be limited by theory, with a k=3 or k=4 Halbach array, the strength of the magnetic field is stronger near the inner surface 124 of the target housing than a k=2 Halbach array of similar strength.

This increased strength may be beneficial to controlling secondary electrons. Also, while the magnetic field of a k=3 or k=4 decreases near the radial center of the target housing 122, when the ion beam 110 is a positive ion beam, the ion beam 110 repels secondary electrons, such as secondary electrons propagating near the radial center of the target housing 122. This repelling force directs the secondary electrons away from the ion beam 110 and toward the stronger parts of the magnetic field of the k=3 or k=4 Halbach array. Without intending to be limited by theory, as the wavenumber (i.e., the k value) increases, the magnetic field becomes more confined near the inner surface of the array.

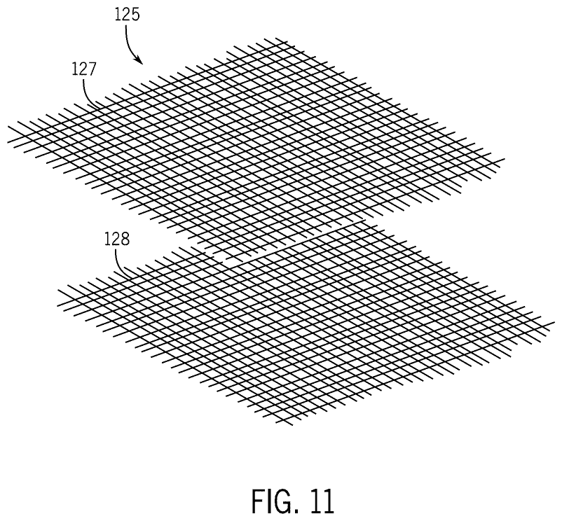

Referring now to FIG. 11, an exploded view of the collection target 125 or a portion thereof (e.g., a fibrous lattice thereof) is shown, according to some embodiments. In the example of FIG. 11, the collection target 125 includes a first lattice 127 and a second lattice 128 which form the collection target 125 as a fibrous lattice. The first lattice 127 and the second lattice 128 may be stacked as layers to form the collection target 125. In other embodiments, other numbers of lattices (layers) are included in the collection target 125 (e.g., one, three, four, five, etc.). The fibrous lattice may be formed as a carbon felt or carbon foam in various embodiments.

The first lattice 127 includes a plurality of fibers arranged in a plurality of directions, shown as two orthogonal directions. The plurality of fibers may be woven together or otherwise coupled to form the first lattice 127. The second lattice 128 also includes a plurality of fibers arranged in a plurality of directions, shown as two orthogonal directions, which are woven together or otherwise coupled to form the second lattice 128. The first lattice 127 and the second lattice 128 may be arranged relative to one another such that fibers of the first lattice 127 are parallel with fibers of the second lattice 128 or may be oriented differently so that fibers of the first lattice 127 are at non-orthogonal angles relative to fibers of the second lattice 128. In some embodiments, the first lattice 127 and the second lattice 128 appear substantially solid to the naked human eye but are made up of fibers at a microscopic or smaller level.

The fibers of the first lattice 127 and the second lattice 128 may be made of carbon, for example FIG. 11 shows a first lattice 127 of carbon fibers and a second lattice 128 of carbon fibers. In some embodiments, the fibers are made of graphite, for example such that some or all of the fibers of the first lattice 127 and the second lattice 128 are graphite fibers. The material of the fibers is preferably a high purity (e.g., greater than 95% carbon) such that, when burned (in the presence of oxygen), the carbon fibers themselves leave little or no solid residue. When in vacuum the carbon fibers are configured to handle high temperatures (e.g., greater than 200° C., greater than 300° C., greater than 800° C.) without substantially deforming, melting, etc.

The first lattice 127 and the second lattice 128 are configured to capture ions incident thereon. The arrangement of the plurality of fibers causes an ion to deflect (scatter, collide, etc.) off of multiple fibers as the kinetic energy of the ion is reduced until the ion will stay at the collection target 125 (e.g., reduce to thermal energy), without scattering away from the collection target 125 after a single collision. The arrangement of the fibers is partially porous, such that some ions are able to penetrate beyond an outer surface of the first lattice 127, thus reducing the amount of energy built up at the surface of the first lattice 127 and allowing ions to scatter multiple times without escaping the collection target 125 (e.g., vaporizing away from the collection target 125). Accordingly, relative to a flat plate or block of material, the lattice structure provides an increased surface area and overlapping geometry that can facilitate capture a high percentage of the ions incident on the collection target 125 (e.g., greater than 40%, greater than 90% in some arrangements). The first lattice 127 and the second lattice 128 thereby provide efficient collection of the desired isotope at the collection target 125.

The first lattice 127 and the second lattice 128 are also configured to burn (in the presence of oxygen) or otherwise react to leave (e.g., be reduced to) a residue that includes a high concentration of the desired isotope. For example, the fibrous lattice configuration of FIG. 11 provides the collection target 125 with an increased surface-area-to-mass ratio as compared to a solid block or plate of carbon or graphite, which enables relatively easy burning of the of the first lattice 127 and the second lattice 128 (e.g., as compared to a solid block of graphite, which typically will not burn). For example, during operation of the ion production system 100, the collection target 125 captures the desired isotope (in the first lattice 127 and the second lattice 128 in the example of FIG. 11) while the collection target 125 is held in vacuum without a substantial amount oxygen present (thereby preventing complete burning of the collection target 125). The collection target 125 can then be removed from vacuum for processing to extract the isotope from fibrous lattice. Outside vacuum, oxygen is present which allows burning of the carbon fibers. The fibrous lattice can then be burned to reduce the fibrous lattice to a residue having a high concentration of the desired isotope. The carbon dissipates as gas after burning, such that the remaining material is of the desired isotope, which may oxidize during the extraction process. For example, in some embodiments, a powder of oxidized ytterbium (e.g., oxidized ytterbium-176) is left as a powder (e.g., white-colored powder) after burning of the target.

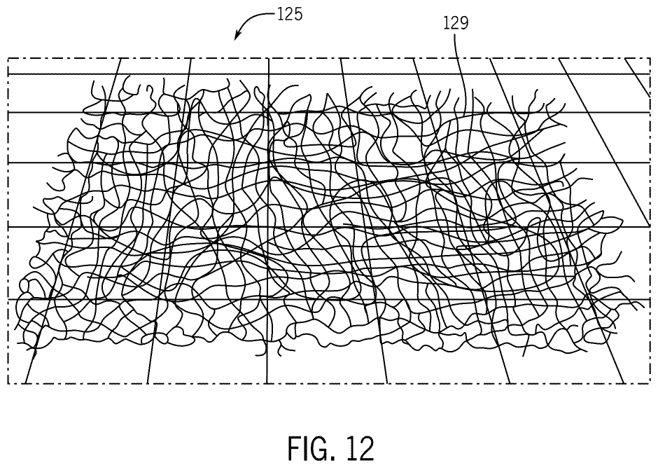

Referring now to FIG. 12, a perspective view of a fibrous lattice 129 of the collection target 125 is shown, according to some embodiments. The fibrous lattice 129 can be used as an alternative to the first lattice 127 and the second lattice 128 of FIG. 11 or may be used in combination with the first lattice 127 and/or the second lattice 128 of FIG. 11 in various embodiments. As shown in FIG. 12, the fibrous lattice 129 includes a plurality of fibers arranged in a tangled web, such that the fibrous lattice 129 may be characterized as an open-celled foam. As in the example of FIG. 12, the plurality of fibers may be carbon fibers and/or graphite fibers. The fibrous lattice 129 is configured to capture ions such that the desired isotope is collected in the fibrous lattice 129. The fibrous structure of the fibrous lattice 129 may cause ions to deflect off multiple fibers before coming to rest in the fibrous lattice 129, without scattering away from the fibrous lattice 129 after a single collision. The fibrous lattice 129 also has a high surface-area-to-mass ratio which facilitates easy burning of the fibrous lattice 129 to reduce the fibrous lattice 129 to a residue having a high concentration of the desired isotope. While collection targets 125 comprising carbon fibers are described herein, it should be understood that the suppression magnet 140 may be used in ion collection assemblies 120 may comprise any collection material that generates electrons from ion beam impacts.

Referring again to FIG. 1, some example ion beams 110, target isotopes, and secondary isotopes are described in more detail below, but it should be understood that the embodiments described herein may include ion beams of all stable and radioactive isotopes. For example, the ion beam 110 may comprise ions of ytterbium (Yb) isotopes, such as ¹⁶⁸Yb, ¹⁷⁰Yb, ¹⁷¹Yb, ¹⁷²Yb, ¹⁷³Yb, ¹⁷⁴Yb, and ¹⁷⁶Yb. In some embodiments, when the ion beam 110 comprises Yb ions, a target beam portion of the ion beam 110 comprises ¹⁷⁶Yb isotopes (e.g., the target isotope) and a secondary beam portion of the ion beam 110 comprises one of more of ¹⁶⁸Yb, ¹⁷⁰ Yb, ¹⁷¹Yb, ¹⁷²Yb, ¹⁷³Yb, and ¹⁷⁴Yb (e.g., the secondary isotopes). ¹⁷⁶Yb may be used in the production of lutetium-177(¹⁷⁷Lu). ¹⁷⁷Lu is a theranostic radionuclide useful for both diagnostic testing and therapeutic treatments. Specifically, during decay ¹⁷⁷Lu emits a low energy beta particle that is suitable for treating cancer, including neuro endocrine tumors, prostate, breast, renal, pancreatic, and other cancers. ¹⁷⁷Lu also emits two gamma rays that can be used for diagnostic testing.

As another example, the ion beam 110 may comprise ions of gadolinium (Gd) isotopes, such as ¹⁵²Gd, ¹⁵⁴Gd, ¹⁵⁵Gd, ¹⁵⁶Gd, ¹⁵⁷Gd, ¹⁵⁸Gd, and ¹⁶⁰Gd. In some embodiments, when the ion beam 110 comprises Gd ions, the target beam portion of the ion beam 110 comprises ¹⁵²Gd isotopes (e.g., the target isotope) and the secondary beam portion of the ion beam 110 comprises one of more of ¹⁵⁴Gd, ¹⁵⁵Gd, ¹⁵⁶Gd, ¹⁵⁷Gd, ¹⁵⁸Gd, and ¹⁶⁰Gd (e.g., the secondary isotopes). ¹⁵²Gd may be used in the production of terbium-149(¹⁴⁹Tb) and ¹⁵²Tb. ¹⁴⁹Tb is a radionuclide useful for both diagnostic testing, for example positron emission tomography (PET) and therapeutic treatments, such as targeted alpha-particle therapy (TAT). ¹⁵²Tb is a radionuclide useful for diagnostic testing, for example PET testing. In other embodiments, when the ion beam 110 comprises Gd ions, the target beam portion comprises ¹⁵⁵Gd isotopes (e.g., the target isotope) and the secondary beam portion of the ion beam 110 comprises one of more of ¹⁵²Gd, ¹⁵⁴Gd, ¹⁵⁶Gd, ¹⁵⁷Gd, ¹⁵⁸Gd, and ¹⁶⁰Gd (e.g., the secondary isotopes). ¹⁵⁵Gd may be used in the production of ¹⁵⁵Tb. ¹⁵⁵Tb is a radionuclide useful for diagnostic testing, for example single photon emission computed tomography (SPECT). In yet other embodiments, when the ion beam 110 comprises Gd ions, the target beam portion comprises ¹⁶⁰Gd isotopes (e.g., the target isotope) and the secondary beam portion comprises one of more of ¹⁵²Gd, ¹⁵⁴Gd, ¹⁵⁵Gd, ¹⁵⁶Gd, ¹⁵⁷Gd, and ¹⁵⁸Gd (e.g., the secondary isotopes). ¹⁶⁰Gd may be used in the production of ¹⁶¹Tb. ¹⁶¹Tb is a radionuclide useful for therapeutic treatments, such as targeted beta-particle therapy. As yet another example, the ion beam 110 may comprise ions of tellurium (Te) isotopes, such as ¹²⁰Te, ¹²²Te, ¹²³Te, ¹²⁴Te, ¹²⁵Te, ¹²⁶Te, ¹²⁸Te, and ¹³⁰Te. In some embodiments, when the ion beam 110 comprises Te ions, the target beam portion of the ion beam 110 comprises ¹²⁴Te isotopes (e.g., the target isotope) and the secondary beam portion of the ion beam 110 comprises one of more of ¹²⁰Te, ¹²²Te, ¹²³Te, ¹²⁵Te, ¹²⁶Te, ¹²⁸Te, and ¹³⁰Te (e.g., the secondary isotopes). ¹²⁴Te may be used in the production of both iodine-123 (¹²³I) and ¹²⁴I. ¹²³I is a radionuclide useful for diagnostic testing, for example PET testing.

As utilized herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical values or idealized geometric forms provided.

Accordingly, these terms should be interpreted as indicating that insubstantial or inconsequential modifications or alterations of the subject matter described and claimed are considered to be within the scope of the disclosure as recited in the appended claims.

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, optical, or fluidic.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

1. An ion collection assembly comprising:
a target housing;
a collection target positioned in the target housing, wherein the collection target is configured to collect ions of an ion beam impinging the collection target; and
a suppression magnet arranged in a Halbach array and positioned around the target housing.

2. The ion collection assembly of claim 1, wherein the target housing comprises an inner surface and the collection target lines the inner surface.

3. The ion collection assembly of claim 1, wherein the suppression magnet is positioned at an entrance opening of the target housing.

4. The ion collection assembly of claim 1, wherein the suppression magnet comprises a plurality of permanent magnets.

5. The ion collection assembly of claim 4, wherein the plurality of permanent magnets each comprise a permanent ferromagnet.

6-10. (canceled)

11. The ion collection assembly of claim 1, wherein the suppression magnet is an electromagnet.

12. The ion collection assembly of claim 1, wherein the Halbach array comprises a k value of 2 or greater.

13-15. (canceled)

16. The ion collection assembly of claim 1, further comprising a cooling substrate positioned between the suppression magnet and the target housing.

17. An ion production system comprising:
the ion collection assembly of claim 1;
an ion source configured to produce ions;
an extraction electrode positioned between the ion source and the collection target and configured to accelerate ions, forming an ion beam along a beam pathway;
a bending magnet positioned along the beam pathway between the extraction electrode and a mass resolving aperture, wherein:
the bending magnet is configured to apply a magnetic field to the ion beam thereby spatially separating a target beam portion of the ion beam and a secondary beam portion of the ion beam; and
the mass resolving aperture is positioned to obstruct the secondary beam portion of the ion beam.

18-28. (canceled)

29. The ion production system of claim 17, wherein the collection target comprises a fibrous lattice, wherein the fibrous lattice comprises a lattice of carbon fibers, graphite fibers, or a combination thereof.

30-31. (canceled)

32. The ion production system of claim 17, wherein the target beam portion of the ion beam comprises ytterbium-176 and the secondary beam portion of the ion beam comprises one or more other ytterbium isotopes.

33. The ion production system of claim 17, wherein the target beam portion of the ion beam comprises gadolinium-152, or gadolinium-160, and the secondary beam portion of the ion beam comprises one or more other gadolinium isotopes.

34-35. (canceled)

36. A method comprising:
accelerating ions from an ion source to form an ion beam using an extraction electrode positioned between the ion source and a mass resolving aperture, wherein the ion beam propagates along a beam pathway toward a collection target;
applying a first magnetic field to the ion beam using a bending magnet positioned along the beam pathway between the extraction electrode and the mass resolving aperture thereby spatially separating a target beam portion of the ion beam and a secondary beam portion of the ion beam;
obstructing the secondary beam portion using the mass resolving aperture; and
collecting ions of the target beam portion on the collection target after the target beam portion of the ion beam passes through the mass resolving aperture; wherein:
the collection target is positioned in a target housing of an ion collection assembly and
a suppression magnet arranged in a Halbach array is positioned around the target housing thereby applying a second magnetic field in the target housing such that electrons generated by the target beam portion of the ion beam striking the collection target are directed back toward the collection target.

37. The method of claim 36, further comprising measuring current in the collection target while collecting ions of the target beam portion on the collection target.

38. The method of claim 36, wherein the target housing comprises an inner surface and the collection target lines the inner surface and wherein the suppression magnet is positioned at an entrance opening of the target housing.

39. (canceled)

40. The method of claim 36, wherein the suppression magnet comprises a plurality of permanent magnets, an electromagnet, or a combination thereof.

41-44. (canceled)

45. The method of claim 36, wherein the Halbach array comprises a k value of 2 or greater.

46-48. (canceled)

49. The method of claim 36, wherein the collection target comprises a lattice of carbon fibers and the method further comprises burning the lattice of carbon fibers to obtain a residue comprising the ions of the target beam portion of the ion beam.

50. The method of claim 36, wherein the first magnetic field spatially separates the target beam portion and the secondary beam portion of the ion beam in a direction non-parallel to the beam pathway.

51. (canceled)

52. The method of claim 36, wherein the second magnetic field comprises a magnetic field within the target housing with a magnetic flux density of 0.5 KG or greater.

53. (canceled)
